(19) United States
(12) Patent Application Publication
(10) Pub. No.: US 2004/0173239 A1
(43) Pub. Date: Sep. 9, 2004

(54) Method for recycling composite materials

(76) Inventor: Erik Grove-Nielsen, Roslev (DK)

Correspondence Address: HARNESS, DICKEY & PIERCE, P.L.C., P.O. BOX 8910, RESTON, VA, 20195, US

(21) Appl. No.: 10/476,333

(22) PCT Filed: Apr. 25, 2002
(86) PCT No.: PCT/DK02/00268

(30) Foreign Application Priority Data
Apr. 30, 2001 (DK) PA 2001 00671

(51) Int. Cl. C23G 1/00; F27B 9/28

(52) U.S. Cl. 134/2; 432/59

(57) ABSTRACT

The invention relates to a method for recovering the glass fibres from composite materials in connection with recycling. This is of particular importance in connection with recycling of glass fibre blades from wind turbines and other fibre reinforced composite materials of the type where glass fibre is embedded in a matrix of polyester, epoxy or a similar polymeric substance or a thermoplastic material. The method of the invention consists in a thermal process in which the material is pyrolysed at a relatively low temperature in a closed furnace chamber with an inactive atmosphere, for example in the form of nitrogen. The temperature and combustion conditions are chosen such that the matrix is glasified while the glass fibres remain intact, thus making recycling possible. The by-product of the pyrolysis is combustible gas, which is carried off from the furnace. The energy in the gas may be utilised for a number of objects, such as: propellant for gas engines in combined heat and power plants or storage for later use. Alternatively, the gas may be burned with a minimum of environmentally damaging wastes, if combustion takes place in the temperature range of 1000-1200° C.

The present invention relates to an environmentally safe method for separating constituents of composite materials containing glass fibre and a matrix material, such as epoxy or polyester resin or a similar curable polymeric substance or a thermoplastic material, with a view to a high degree of recycling of the materials. The readily usable glass fibre material is retained, whereas the energy content of the matrix material may be converted into an energy form which permits utilisation in engines having a high efficiency. By way of example, the method is suitable for recycling of glass fibre blades from wind turbines.

### BACKGROUND

Recycling of wind turbine blades and similar voluminous objects made from composite materials constitutes a problem, partly as a consequence of the large dimensions of the items, and partly as a consequence of the general difficulty of recycling compounded materials of the subject nature. Attempts have been made to recycle composite material as filling material in plastics and rubbers after appropriate breaking of the material into granulate or powder. However, filling materials of this type are already largely available on the market and, consequently, the demand is limited and the price is low. Moreover, the poorly defined fibre content of the composite materials will be problematic, e.g. when the plastic or rubber is later to be recycled. By way of example, the fields of application may be for marking material for road works, cubicle mats for stables, floor gratings and similar discount products.

Another known application of discarded composite material is use as fuel supplement for large combustion plants, where the high calorific value of the matrix material is utilised in combustion. For this application, breaking into lumps having a dimension of approx. one centimetre is adequate. Even this relatively coarse breaking of the composite material is, however, costly and makes the method unprofitable. Furthermore, considerable inconveniences in the working environment are caused by allergising dust arising from the breaking of particularly glass fibre-reinforced epoxy plastic. Environmentally, the method is problematic as combustion is difficult to control to such an extent that discharge of environmentally damaging substances is completely avoided. Discharge of dioxin and NOₓs from the combustion plant is increased by combustion of polyester, epoxy and other similar polymers, and heavy metals from gel coat, adhesives and other auxiliaries in the items accompany the flue gas into the surrounding environment to a certain extent. In the combustion plant the material's content of glass fibre is lost in the slag. Thus, the glass fibres' content of very fine glass raw material cannot be recycled, but acts as an undesirable slag product For depositing.

Particularly wind turbine blades constitute a growing problem as the first generations of wind turbines from the 1970s and the 1980s are being scrapped. The politically passed resolution in Denmark alone as to the replacement of turbines of under 100 kW involves scrapping of 1200-1800 tons of glass fibre. In 2002 the total wind turbine capacity erected in Europe exceeds 20,000 MW, corresponding to more than 40,000 tons of glass fibre-reinforced composite material in the rotors having a life span of approx. 15-20 years. Besides old blades, a number of new blades are also being scrapped as a consequence of e.g. cracks arisen due to oscillations at the edges and damages caused by lightning. The blades, typically made from glass fibre-reinforced polyester laid up by hand, are deposited at municipal waste disposal sites. However, new legislation demands that the material be recycled instead of being deposited. Recycling of the material's glass fibre content for e.g. glass or fibre production is attractive due to the high fineness and thus relatively high price of the glass material. Recycling of the glass requires that it may be isolated in a chemically unchanged condition and cleaned of all impurities.

### DISCUSSION OF PRIOR ART

German patent application DE 4442814 describes a method for recycling composite materials by separating the material into the individual constituents by using solvents. By such a separation of the fibres from the matrix material it is possible to recycle the glass fibres of the composite material.

However, this method has a number of disadvantages. The necessary solvents are hazardous to health, and consequently it is a demanding process to carry into effect, particularly on large items, as extensive precautionary measures must be taken in order to avoid discharge or loss of solvents. Moreover, the process is time-consuming: 3-24 hours, depending on the material. The method is less applicable for composite materials containing different types of fibres, e.g. a mixture of glass fibres and carbon fibres, as the separated fibres will be a mixture which is difficult to separate.

### DESCRIPTION OF THE INVENTION

The object of the present invention is to provide an alternative method for recovering the glass fibres from the composite material, in which the above-mentioned disadvantages are overcome. According to the invention the solution is to pyrolyse the composite material at a relatively low temperature in a closed furnace chamber, optionally with an inactive atmosphere. At the correct temperature, the polyester or epoxy material will gasify while the glass fibres remain substantially intact, both chemically and physically. The temperature depends on the material treated. To retain the glass fibre material, a temperature in the range of 450-800° C. will be appropriate, depending on the matrix material and the final product desired. Thermoplastic materials are pyrolysed already from about 300° C., and the process has an industrially applicable rate from about 450° C., whereas e.g. epoxy resin has to be heated to at least 480-500° C., preferably at least 550° C., to attain an industrially applicable pyrolysis rate. The maximum temperature depends on the glass type, but should not exceed 650-680° C., preferably not exceed 625° C., if the glass material is to be recycled as glass fibre. After extended heating to 700-800° C., the glass fibres are converted into a brittle material, which is readily pulverised to a powdered material that may be recyded as raw material in glass production, and heating to this temperature range is also included in the present invention. Any further fibre types of the composite material, such as: kevlar, carbon, wood, hemp, coconut or sisal fibres will burn at a temperature above approx. 500° C., which leaves substantially only the glass fibre material. By treating the composite material in an independent process, the course of the process may be controlled so that the environmental strain in connection with separation of the composite material may be minimised or eliminated.

The length of the process time is also advantageous compared to the prior art for separation with a view to recycling. For thick-walled composite materials the process duration is 1-2 hours, whereas it is approx. 10-15 minutes for thin-walled items having a thickness of e.g. 4 millimetres.

The inactive atmosphere in the furnace chamber arises by itself, if the inflow of atmospheric air to the furnace chamber is substantially stopped in the pyrolysis process, as the atmospheric oxygen present at the beginning of the process is quickly reacted with the liberated gas with generation of heat. The inactive atmosphere may also be obtained by feeding an inactive gas, such as nitrogen, to the furnace it is advantageous to seal the furnace in an appropriate manner so that penetration of oxygen-containing atmospheric air into the furnace chamber is substantially prevented, as the presence of oxygen may cause danger of explosion in the furnace chamber.

The gases developed may be utilised in a gas engine for combined electricity and heat generation as in existing combined heat and power plants. Alternatively the gas may be used in burners, fuel cells and gas turbines, or the gas may be collected and stored in tanks for later use. Collection may be effected by compression or condensing of the gas. By adding water vapour, particularly superheated water vapour, to the furnace chamber during the pyrolysis or to a subsequent gasification chamber, it is possible, according to the invention, to produce water gas, thus making it possible to attain a higher rate of efficiency.

Instead the gas may be combusted in a separate combustion chamber into which the gases are fed along with atmospheric air. When combusted, the gases react with the oxygen of the air under liberation of heat, which may be utilised for heating. The combustion temperature should be in the order of 1000-1200° C. Thus, the temperature is sufficiently high to prevent discharge of dioxin along with the residual gases. The content of NOₓ and CO in the combustion products may be kept at a minimum level by appropriate control of the combustion. The residual products CO₂ and H₂O are discharged to the atmosphere after clearing of soot particles and any heavy metals.

It may be a further advantage, particularly for thick-walled composite items, to rotate items in the pyrolysis process period to obtain a smoothly running process. By rotation of the item, either in the form of a constant rotation or a periodic change of position, e.g. by turning the item, it is possible to ensure partly that heat is supplied evenly to the entire surface, and partly that the matrix material may be gasified evenly so that remaining glass fibres may flake off and let the heat penetrate into the inner parts of the item. Rotation may be effected by suspension of the item in one or two rotatable holders at one end or both ends respectively, in a longitudinal direction of the item, the item being suspended in said holders before the beginning of the process, but rotation is preferably caused by movement of the base on which the item is resting in the furnace chamber, in one direction, while fixed retaining devices or teeth having a wedge shape, such as having a curved upper side, cause the item or the items in the furnace chamber to rotate or to be turned around a preferably horizontal axis. Alternatively, a rotating furnace as known e.g. from the manufacture of cement clinkers, may be used.

For purification of the glass fibres being the solid residue in the furnace chamber after the pyrolysis process, a secondary process may be carried out in which the glass fibres are heated in an oxygen-containing atmosphere for the combustion of particularly coal residues between the fibres. This secondary process may be carried out in the furnace chamber by supply of e.g. atmospheric air or another oxygen-containing gas, but the secondary process may alternatively be carried out in a separate furnace chamber into which the glass fibres are fed from the first mentioned furnace chamber in which the pyrolysis process takes place. The secondary process in a separate furnace chamber may e.g. be carried out as a continuous process in which the glass fibres are passed through the chamber on a conveyor. The temperature should be above 600° C. in order to obtain effective purification and should not exceed 650-680° C. and 800° C., respectively, depending on the contemplated recycling form of the glass, cf. the above discussion.

The pyrolysis technique is known per se in connection with a number of other applications, for example as described in patent application WO 96/30700 which relates to hygienic disposal of biologic material by degassing thereof and combustion of the gas, and GB 2 274 908 which relates to disposal of used car tyres. Pyrolysis is also known in connection with ensuring utilisatlon for energy purposes by incineration, for example in connection with incineration of straw as described in patent application WO 88/09364. By this type of incineration, the relatively low temperature of the pyrolysis process in the first chamber prevents slagging compared to incineration of the straw at a higher temperature, together with favourable energy utlilsation in connection with the subsequent combustion of the gas at a higher temperature. Pyrolysis is also known in connection with the production of gas from hard coal.

The use of pyrolysis for separation of materials in connection with recycling is novel. According to the present invention the pyrolysis process is used to separate composite materials in such a manner that the glass fibres are produced by the process in a form which may either be utilised immediately or after simple purification. The glass may be processed further into shorter fibres or pulverised fibres which may be used in the production of new composite materials. At the same time the known effect of pyrolysis is utilised, i.e. an effective use of the energy in the parts of the materials not to be retained.

The method, thus, permits recycling of the glass fibre material along with utilisation of the energy of the matrix material. The method may ensure recycling of e.g. scrapped wind turbine blades and similar voluminous objects of fibre composite material which are today typically simply deposited at a disposal site. Moreover, the process is environmentally desirable as, as stated above, the combustion products from the gas combustion generally speaking only consist of the environmentally neutral substances CO₂ and H₂O.

### EXAMPLE OF EMBODIMENT OF THE INVENTION

According to the invention, the described separation process may, in combination with utilisatlon of the energy of the resulting gas, advantageously be carried out in a plant consisting mainly of a closed pyrolysis furnace and a combustion chamber for the gases generated in the pyrolysis process. The size of the pyrolysis furnace is adapted to the largest items to be destructed, so that breaking of the material is avoided. The furnace is suitably designed with a grid tray and with a circulation blower inserted in the furnace chamber itself so that the heated gas in the furnace may circulate effectively around all parts of the destruction item or items. Thereby, the pyrolysis process is accelerated. Heating of the furnace is effected by supplying external heat energy in the form of electricity or gas. In a particular embodiment of the invention the combustion chamber is placed inside the pyrolysis furnace. In this way it is achieved that the combustion chamber may contribute to the heating of the fumace chamber so as to save heat energy for the pyrolysis process. The furnace is thermally insulated and is made gastight of corrosion-resistant materials.

The combustion chamber is in communication with the pyrolysis furnace through a pipe connection and is provided with means for combustion control, including temperature control, oxygen control and controlled supply of atmospheric air to the combustion zone. In this manner gas combustion may be carried out in an environmentally sound way, cf. the comments hereon above. The combustion chamber is suitably designed with heat exchanger pipes or similar heat exchanger devices for cooling the combustion products before they are discharged into the atmosphere, so that the intended utlilsation of the excess heat for e.g. heating purposes or for heating of the pyrolysis furnace, may take place.

### BRIEF DESCRIPTION OF FIGURES

The invention will be described more detailed below in connection with the drawings in which

FIG. 1 shows a furnace plant according to the invention in schematic form,

FIG. 2 shows the pyrolysis furnace of the plant shown separately in a side view, partly sectional,

FIG. 3 is a front view of the same in a view along line A-A in FIG. 2, and

FIG. 4 shows the pyrolysis furnace in cross section along line B-B in FIG. 2.

### DETAILED DESCRIPTION OF THE INVENTION

In the embodiment shown in the drawing, the recycling plant mainly consists of a pyrolysis furnace 1 and a combustion chamber 2. The pyrolysis furnace is shown treating a wind turbine blade V in the furnace chamber.

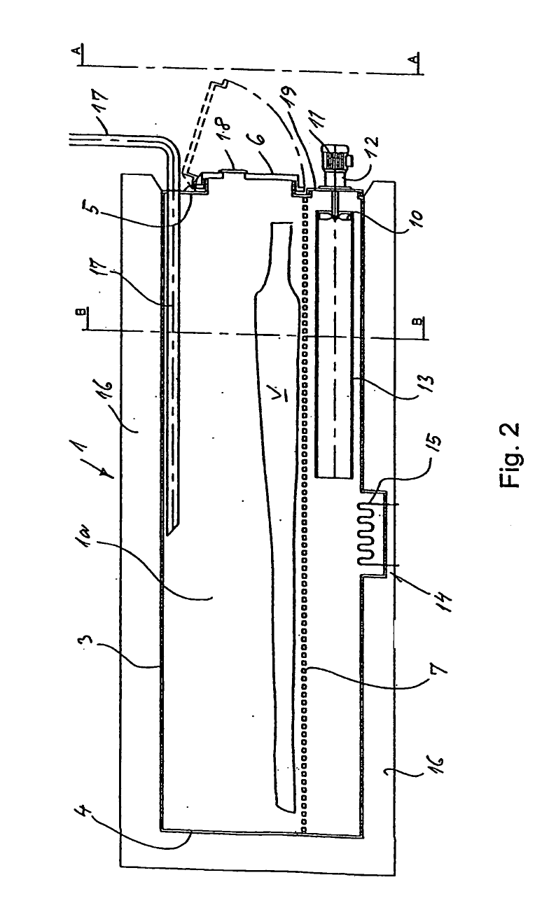

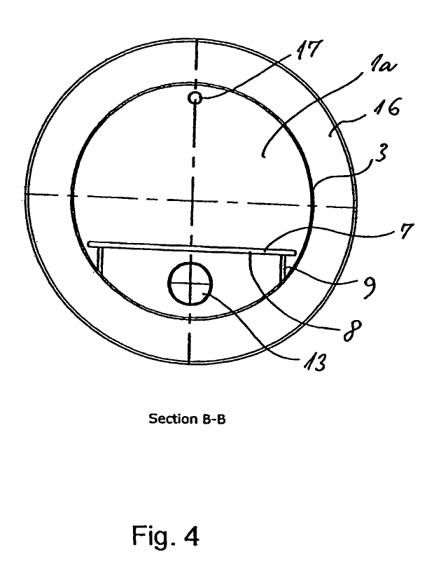

The pyrolysis furnace 1 is constructed as an elongated tunnel furnace having a circular cross section. The furnace chamber 1a itself is composed of a cylindrical shell 3, a back end bottom 4 and a front end 5. The front end 5 is provided with a top hinged door 6 giving access to the furnace chamber 1a in its open position. Inside the furnace a horizontal grid tray 7 is arranged, said grid tray being composed of a number of parallel, transversal steel profiles 8 that are mounted on a longitudinal rail 9 at each side of the furnace chamber (see FIGS. 2 and 4).

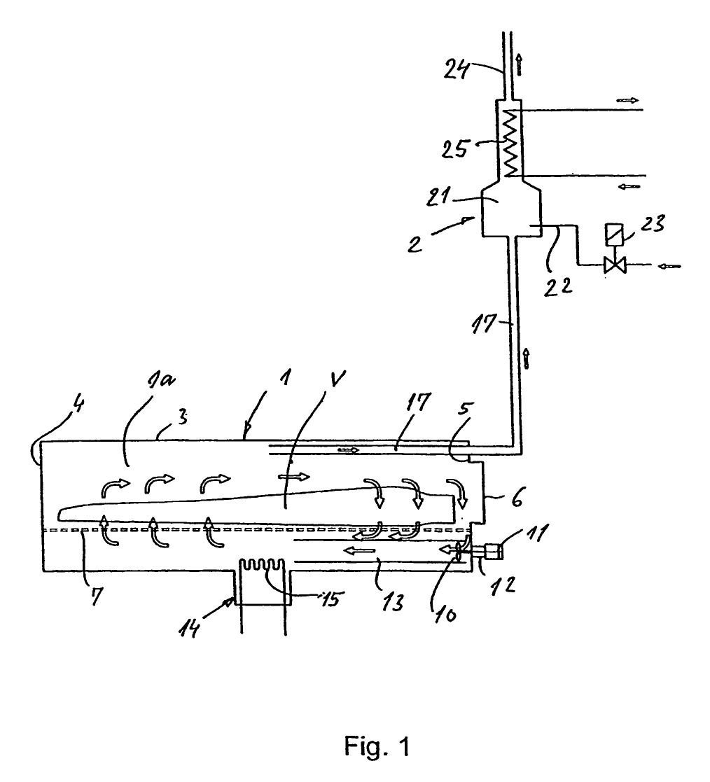

Under the grid tray 7 a circulation blower 10 is inserted. This blower is driven by a motor 11 placed on the outside of the furnace. Between the engine and the blower 10 itself, an intermediate flange 12 is inserted, placing the motor in an appropriate distance from the hot furnace wall. The blower 10 is inserted in an open, horizontal air distributor pipe 13 which distributes the blast air inside the furnace chamber. The air circulation is indicated by arrow markings in FIG. 1. The air distributor pipe 13 is situated immediately under the grid tray 7.

An electric heating element 14 is built into the under part of the furnace, said heating element consisting of a tubular heating element 15 provided with heating fins not shown or similar heat exchanger faces. The circulating air from the air distributor pipe 13 is brought in direct contact with the heating element when the air leaves the pipe, and is thus heated. The air (inactive gas) is heated to the pyrolysis temperature which is in the order of 500-625° C. for polyester. The furnace is provided with an outside thermal insulation 16.

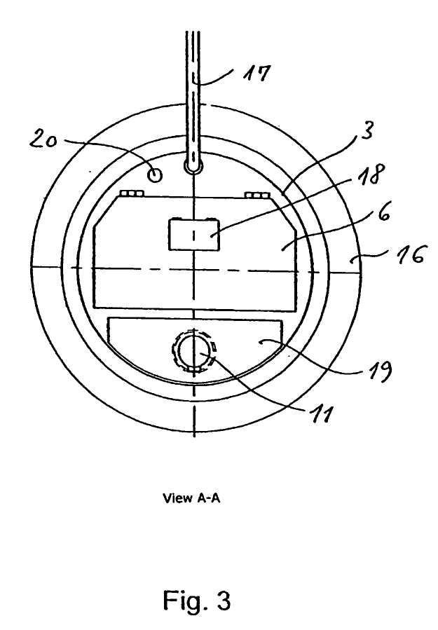

In the pyrolysis process the polyester of the glass fibre blade V is decomposed into volatile gases. These gases are blended into the circulating air, and as degradation of the blade takes place, the gas is discharged through a pipe 17 built into the top part of the furnace chamber 1a. The gas is fed through this pipe to the combustion chamber 2. In consideration of the danger of explosion in the process, the furnace chamber 1a is filled with inactive gas, for example nitrogen, before the pyrolysis process (the heating) is initiated in the front door 6, a safety explosion vent shutter 18 is arranged, see FIG. 3. After final pyrolysis of the blade V, the fibre reinforcement is left on the grid tray 7 as a loose layer which may be scraped out through the door 6. Some residual products from the blade, for example paint pigments, stiffening agent, residues from topcoating, etc. generate a loose powder which partly falls through the grid. This residual product is scraped out from the furnace chamber through a removable ash door 19 in the front of the furnace. The blower motor 1 is flange mounted on this ash door 19, which for this purpose is designed with a circular opening. Furthermore, an observation door 20 is arranged in the front side of the furnace.

The combustion chamber 2, shown schematically in FIG. 1, consists of a closed, heat insulated chamber 21. The gas outlet pipe 17 feeds the pyrolysis gas to this chamber, where atmospheric air is supplied through a tubing 22 provided with a flow control valve 23. By reaction with the oxygen of the air, the gas is completely combusted at a temperature of approx. 1000-1200° C. The combustion products, substantially CO₂ and H₂O, leave the combustion chamber through an outlet pipe 24. Before discharge into the open, the combustion products pass a heat exchanger 25, where the excess heat of the gases is removed. The heat is utilised in a heating plant not shown.

The invention is not limited to the embodiment shown in the drawings and described above. The pyrolysis process may be carried out in different types of plants, and the gas may be utilised in different ways by collection or combustion in e.g. a gas engine or a turbine, e.g. mixed with another gas, such as methane-containing natural gas. Variations in the process and the process parameters, depending on the constituents used in the composite material, and different applications of the gas are considered to lie within the capacity of a person skilled in the art and thus to be covered by the protection.

1. A method for recovering the glass fibre material from composite materials containing glass fibre imbedded in matrix material, such as epoxy or polyester resin or a thermoplastic material, by heating the composite material in a substantially inactive atmosphere in a closed furnace chamber (1a) to a process temperature between 450-650° C. during a process period, by means of which substantially all the matrix material is converted into gas, which is carried off while the glass fibres remain substantially intact and may, after the process period, be withdrawn from the furnace chamber for recycling.

2. A method according to claim 1, wherein the heating temperature is 480-625° C. and preferably 550-625° C.

3. A method according to claim 1, wherein the inactive atmosphere in the furnace chamber is ensured by purging with substantially pure nitrogen (N₂).

4. A method according to any of the cldaims 1-3, wherein the carried off gas is burned at a temperature of 1000-1200° C.

5. A method according to any of the preceding claims, wherein water vapour is added to the furnace chamber during the process period or in a subsequent gasification chamber.

6. A method according to any of the preceding claims, further comprising the step of rotating the composite material during the process period in order to obtain a smoothly running process.

7. A method according to any of the preceding claims, comprising, after said process period, a secondary process in which the glass fibres are heated in an oxygen-containing atmosphere for combustion of particularly carbon residue between the fibres.

8. A method according to claim 7, wherein the glass fibres in the secondary process are heated to 600-800°C., preferably to 600-680° C.
